(19) United States
(12) Patent Application Publication
(10) Pub. No.: US 2022/0212976 A1
(43) Pub. Date: Jul. 7, 2022

(54) METHODS AND APPARATUS FOR MANUFACTURING A RIBBON

(71) Applicant: CORNING INCORPORATED, CORNING, NY (US)

(72) Inventors: Xinghua Li, Horseheads, NY (US); Anping Liu, Horseheads, NY (US)

(21) Appl. No.: 17/602,500

(22) PCT Filed: Apr. 1, 2020
(86) PCT No.: PCT/US2020/026072

§ 371 Date: Oct. 8, 2021

Related U.S. Application Data
(60) Provisional application No. 62/833,260, filed on Apr. 12, 2019.

(51) Int. Cl. C03B 17/06

(52) U.S. Cl. CPC C03B 17/064

(57) ABSTRACT

Methods of manufacturing a ribbon can comprise identifying a location of a nonuniformity in a characteristic of a molten portion of a moving ribbon. The methods can further comprise impinging a deflected pulsed laser beam on a heating zone comprising a location of a nonuniformity in the molten portion of the ribbon. In some embodiments, the heating zone can be elongated in a travel direction of a travel path of the moving ribbon. In some embodiments, the pulsed laser beam can be reflected off a reflective surface of a polygonal reflecting device rotating at a substantially constant angular velocity. In some embodiments, the methods can include impinging the deflected pulsed laser beam on a sensing device to generate a signal. The methods can further comprise calibrating a location of the deflected pulsed laser beam based on the signal from the sensing device.

### CROSS-REFERENCE TO RELATED APPLICATIONS

This application claims the benefit of priority of U.S. Provisional Application Ser. No. 62/833,260 filed on Apr. 12, 2019 the contents of which are relied upon and incorporated herein by reference in their entirety as if fully set for the below.

### FIELD

The present disclosure relates generally to methods and apparatus for manufacturing a ribbon and, more particularly, to methods and apparatus for heating a location of a nonuniformity of a molten portion of the ribbon.

### BACKGROUND

It is known to control a thickness of a molten portion of a ribbon with a laser beam directed to a preselected portion of the molten portion of the ribbon. The laser beam can increase the temperature and reduce a viscosity of the preselected portion of the molten portion of the ribbon to cause the preselected portion to attain a desired thickness prior to cooling the molten portion to a glass portion of the ribbon.

### SUMMARY

Some example embodiments of the disclosure are described below with the understanding that any of the embodiments may be used alone or in combination with one another.

Embodiment 1. A method of manufacturing a ribbon can comprise moving the ribbon along a travel direction of a travel path. The method can further comprise identifying a location of a nonuniformity in a characteristic of a molten portion of the ribbon. The method can further comprise deflecting a pulsed laser beam. The method can further comprise impinging the deflected pulsed laser beam on a heating zone comprising the location of the nonuniformity. The heating zone can be elongated in the travel direction of the travel path.

Embodiment 2. The method of embodiment 1, wherein the deflecting the pulsed laser beam can comprise reflecting the pulsed laser beam off a reflective surface of a polygonal reflecting device.

Embodiment 3. The method of embodiment 2, wherein the method can further comprise rotating the polygonal reflecting device at a substantially constant angular velocity about a rotation axis of the polygonal reflecting device.

Embodiment 4. The method of any one of embodiments 1-3, wherein the method can further comprise impinging the deflected pulsed laser beam on a sensing device to generate a signal, and calibrating a location of the deflected pulsed laser beam based on the signal from the sensing device.

Embodiment 5. A method of manufacturing a ribbon can comprise moving the ribbon along a travel direction of a travel path. The method can further comprise identifying a location of a nonuniformity in a characteristic of a molten portion of the ribbon on a treatment path of the molten portion of the ribbon. The method can further comprise reflecting a pulsed laser beam off a reflective surface of a polygonal reflecting device. The reflected pulsed laser beam can impinge on a heating zone on the treatment path. The method can further comprise rotating the polygonal reflecting device at a substantially constant angular velocity about a rotation axis of the polygonal reflecting device to move the heating zone along the treatment path. The heating zone can comprise the location of the nonuniformity.

Embodiment 6. The method of embodiment 5, wherein the method can further comprise impinging the reflected pulsed laser beam on a sensing device to generate a signal at a second angular orientation of the polygonal reflecting device, and calibrating a location of the reflected pulsed laser beam based on the signal from the sensing device.

Embodiment 7. A method of manufacturing a ribbon can comprise moving the ribbon along a travel direction of a travel path. The method can further comprise identifying a location of a nonuniformity in a characteristic of a molten portion of the ribbon. The method can further comprise deflecting a pulsed laser beam. The method can further comprise impinging the deflected pulsed laser beam on a heating zone of the location of the nonuniformity. The method can further comprise impinging the deflected pulsed laser beam on a sensing device. Impinging the deflected pulsed laser beam on the sensing device generates a signal. The method can further comprise calibrating a location of the deflected pulsed laser beam based on the generated signal.

Embodiment 8. The method of embodiment 7, wherein the deflecting the pulsed laser beam can comprise reflecting the pulsed laser beam off a reflective surface.

Embodiment 9. The method of any one of embodiments 1-8, wherein the characteristic can comprise a thickness of the ribbon.

Embodiment 10. The method of any one of embodiments 1-8, wherein the characteristic can comprise a temperature of the ribbon.

Embodiment 11. The method of any one of embodiments 1-10, wherein the pulsed laser beam can comprise a wavelength in a range from about 0.9 micrometers to about 12 micrometers.

Embodiment 12. The method of any one of embodiments 1-11, wherein the pulsed laser beam can be generated by a CO₂ laser generator.

Embodiment 13. The method of any one of embodiments 1-12, wherein the pulsed laser beam can impinge on the heating zone at a beam spot that may be repeatedly moved within the heating zone along the travel path.

Embodiment 14. The method of any one of embodiments 1-12, wherein the pulsed laser beam can comprise a plurality of pulsed laser beams impinging on the heating zone at corresponding beam spots arranged as an array of beam spots aligned in the travel direction of the travel path.

Embodiment 15. The method of embodiment 14, wherein the method can further comprise splitting the generated pulsed laser beam into the plurality of pulsed laser beams.

Embodiment 16. The method of any one of embodiments 1-12, wherein the heating zone can comprise an elliptical shape comprising a major axis extending in the travel direction of the travel path.

Embodiment 17. The method of embodiment 16, wherein the method can further comprise passing the pulsed laser beam through a cylindrical lens to generate the elliptical shape.

Embodiment 18. The method of embodiment 16, wherein the method can further comprise passing the pulsed laser beam through an anamorphic prism to generate the elliptical shape.

Embodiment 19. The method of any one of embodiments 1-18, wherein the method can further comprise controlling a characteristic of the pulsed laser beam to control a heating of the location of the nonuniformity.

Embodiment 20. The method of embodiment 19, wherein the characteristic of the pulsed laser beam can comprise a pulse frequency of the pulsed laser beam.

Embodiment 21. The method of any one of embodiments 19-20, wherein the characteristic of the pulsed laser beam can comprise a pulse width of the pulsed laser beam.

Embodiment 22. The method of any one of embodiments 19-21, wherein the characteristic of the pulsed laser beam can comprise a duty cycle of the pulsed laser beam.

Embodiment 23. The method of any one of embodiments 19-22, wherein heating the location of the nonuniformity can cause the nonuniformity to dissipate.

Embodiment 24. The method of any one of embodiments 1-23, wherein a width the heating zone across the travel path can be in a range from about 100 micrometers to about 30 millimeters.

Embodiment 25. The method of any one of embodiments 1-24, wherein the method can further comprise selectively controlling an elongated length of the heating zone extending in the travel direction.

Embodiment 26. The method of any one of embodiments 1-24, wherein the heating zone can comprise an elongated length extending in the travel direction in a range from about 1 millimeter to about 100 millimeters.

Embodiment 27. The method of embodiment 26, wherein the method can further comprise selectively controlling the elongated length of the heating zone.

Embodiment 28. The method of any one of embodiments 25-27, wherein a ratio of the elongated length of the heating zone to a width of the heating zone across the travel path can be about 3 or more.

Embodiment 29. The method of embodiment 28, wherein the width the heating zone can be in a range from about 100 micrometers to about 30 millimeters.

Additional embodiments disclosed herein will be set forth in the detailed description that follows. It is to be understood that both the foregoing general description and the following detailed description present embodiments intended to provide an overview or framework for understanding the nature and character of the embodiments disclosed herein. The accompanying drawings are included to provide further understanding, and are incorporated into and constitute a part of this specification. The drawings illustrate various embodiments of the disclosure, and together with the description explain the principles and operations thereof.

### BRIEF DESCRIPTION OF THE DRAWINGS

These and other embodiments are better understood when the following detailed description is read with reference to the accompanying drawings, in which:

FIG. 1 schematically illustrates an exemplary embodiment of a glass manufacturing apparatus configured to form a ribbon in accordance with embodiments of the disclosure;

FIG. 2 shows a perspective cross-sectional view of the glass manufacturing apparatus along line 2-2 of FIG. 1 in accordance with embodiments of the disclosure;

FIG. 3 shows an enlarged view of one embodiment of a heating zone taken at view 3 of FIG. 2;

FIG. 4 shows an enlarged view of another embodiment of a heating zone taken at view 3 of FIG. 2;

FIG. 5 shows an enlarged view of another embodiment of a heating zone taken at view 3 of FIG. 2;

FIG. 6 shows an enlarged view of another embodiment of a heating zone taken at view 3 of FIG. 2;

FIG. 7 shows an enlarged view of another embodiment of a heating zone taken at view 3 of FIG. 2;

FIG. 8 shows an enlarged view of another embodiment of a heating zone taken at view 3 of FIG. 2;

FIG. 9 illustrates a schematic perspective view of embodiments of a treatment apparatus impinging a deflected pulsed laser beam on a heating zone of a molten portion of the ribbon; and

FIG. 10 illustrates a sensing device configured to generate a signal for use to calibrate a location of the deflected pulsed laser beam.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

The present disclosure relates to a glass manufacturing apparatus and methods for manufacturing a ribbon from a quantity of molten material. In some embodiments, the ribbon may comprise a molten portion that may be cooled to a glass portion. A slot draw apparatus, float bath apparatus, down-draw apparatus, up-draw apparatus, press-rolling apparatus or other glass manufacturing apparatus can be used to form the ribbon from a quantity of molten material.

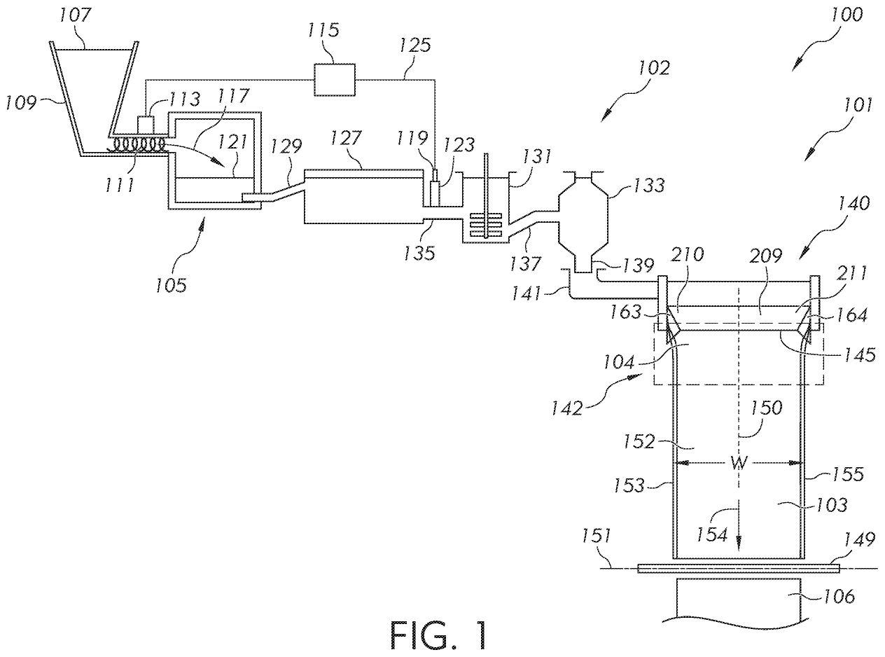

Methods and apparatus for manufacturing glass will now be described by way of exemplary embodiments for forming a ribbon from a quantity of molten material. As schematically illustrated in FIG. 1, in some embodiments, an exemplary glass manufacturing apparatus 100 can comprise a glass melting and delivery apparatus 102, a forming apparatus 101 including a forming vessel 140 designed to produce a molten portion 104 of a ribbon from a quantity of molten material 121, and/or a treatment apparatus 142 designed to treat the molten portion 104 of the ribbon. For purposes of this application, the “molten portion” of the ribbon is considered the portion of the ribbon comprising a viscosity within a range of from about 10⁴ to about 10^{7.6} Poise. In some embodiments, the glass manufacturing apparatus 100 can be considered the treatment apparatus 142 without requiring features of the glass melting and delivery apparatus 102 or the forming apparatus 101. In further embodiments, the glass manufacturing apparatus 100 can be considered the treatment apparatus 142 in combination with features of the forming apparatus 101 without requiring features of the glass melting and delivery apparatus 102. In further embodiments, the glass manufacturing apparatus 100 may comprise the treatment apparatus 142 in combination features of the glass melting and delivery apparatus 102 and the forming apparatus 101.

In some embodiments, the molten portion 104 of the ribbon may be cooled into a glass portion 103 of the ribbon comprising a central portion 152 disposed between a first outer edge 153 and a second outer edge 155 of the ribbon. Additionally, in some embodiments, a separated glass ribbon 106 can be separated from the glass portion 103 of the ribbon along a separation path 151 by a glass separator 149 (e.g., scribe, score wheel, diamond tip, laser, etc.).

In some embodiments, the glass melting and delivery apparatus 102 can include a melting vessel 105 oriented to receive batch material 107 from a storage bin 109. The batch material 107 can be introduced by a batch delivery device 111 powered by a motor 113. In some embodiments, an optional control device 115 (e.g., programmable logic controller) can be configured to (e.g., “programmed to”, “encoded to”, “designed to”, and/or “made to”) operated to activate the motor 113 to introduce a desired amount of batch material 107 into the melting vessel 105, as indicated by arrow 117. The melting vessel 105 can heat the batch material 107 to provide molten material 121. In some embodiments, a melt probe 119 can be employed to measure a level of molten material 121 within a standpipe 123 and communicate the measured information to the control device 115 by way of a communication line 125.

Additionally, in some embodiments, the glass melting and delivery apparatus 102 can include a first conditioning station including a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass melting and delivery apparatus 102 can further include a second conditioning station including a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 through an interior pathway of the second connecting conduit 135 from the fining vessel 127 to the mixing chamber 131.

Additionally, in some embodiments, the glass melting and delivery apparatus 102 can include a third conditioning station including a delivery vessel 133 that can be located downstream from the mixing chamber 131. In some embodiments, the delivery vessel 133 can condition the molten material 121 to be fed into an inlet conduit 141. For example, the delivery vessel 133 can function as an accumulator and/or flow controller to adjust and provide a consistent flow of molten material 121 to the inlet conduit 141. As shown, the mixing chamber 131 can be coupled to the delivery vessel 133 by way of a third connecting conduit 137. In some embodiments, molten material 121 can be gravity fed from the mixing chamber 131 to the delivery vessel 133 by way of the third connecting conduit 137. For example, in some embodiments, gravity can drive the molten material 121 through an interior pathway of the third connecting conduit 137 from the mixing chamber 131 to the delivery vessel 133. As further illustrated, in some embodiments, a delivery pipe 139 can be positioned to deliver molten material 121 to forming apparatus 101, for example the inlet conduit 141 of the forming vessel 140.

Forming apparatus 101 can comprise various embodiments of forming vessels in accordance with features of the disclosure including a forming vessel with a wedge for fusion drawing the ribbon, a forming vessel with a slot to slot draw the ribbon, or a forming vessel provided with press rolls to press roll the ribbon from the forming vessel. By way of illustration, the forming vessel 140 shown and disclosed below can be provided to fusion draw molten material 121 off a bottom edge, defined as a root 145, of a forming wedge 209 to produce the molten portion 104 of the ribbon that can be drawn and cooled into the glass portion 103 of the ribbon. For example, in some embodiments, the molten material 121 can be delivered from the inlet conduit 141 to the forming vessel 140. The molten material 121 can then be formed into the molten portion 104 of the ribbon based at least in part on the structure of the forming vessel 140. For example, as shown, the molten material 121 can be drawn as the molten portion 104 off the root 145 of the forming vessel 140 and moved along a travel direction 154 of a travel path 150.

In some embodiments, edge directors 163, 164 can direct the molten portion 104 off the forming vessel 140 and help define a width “W” of the resulting glass portion 103 of the ribbon. In some embodiments, the width “W” of the glass portion 103 can extend between the first outer edge 153 of the glass portion 103 and the second outer edge 155 of the glass portion 103. In some embodiments, the width “W” of the glass portion 103 can be greater than or equal to about 20 mm, such as greater than or equal to about 50 mm, such as greater than or equal to about 100 mm, such as greater than or equal to about 500 mm, such as greater than or equal to about 1000 mm, such as greater than or equal to about 2000 mm, such as greater than or equal to about 3000 mm, such as greater than or equal to about 4000 mm, although other widths less than or greater than the widths mentioned above can be provided in further embodiments. For example, in some embodiments, the width “W” of the glass portion 103 can be from about 20 mm to about 4000 mm, such as from about 50 mm to about 4000 mm, such as from about 100 mm to about 4000 mm, such as from about 500 mm to about 4000 mm, such as from about 1000 mm to about 4000 mm, such as from about 2000 mm to about 4000 mm, such as from about 3000 mm to about 4000 mm, such as from about 20 mm to about 3000 mm, such as from about 50 mm to about 3000 mm, such as from about 100 mm to about 3000 mm, such as from about 500 mm to about 3000 mm, such as from about 1000 mm to about 3000 mm, such as from about 2000 mm to about 3000 mm, such as from about 2000 mm to about 2500 mm, and all ranges and subranges therebetween.

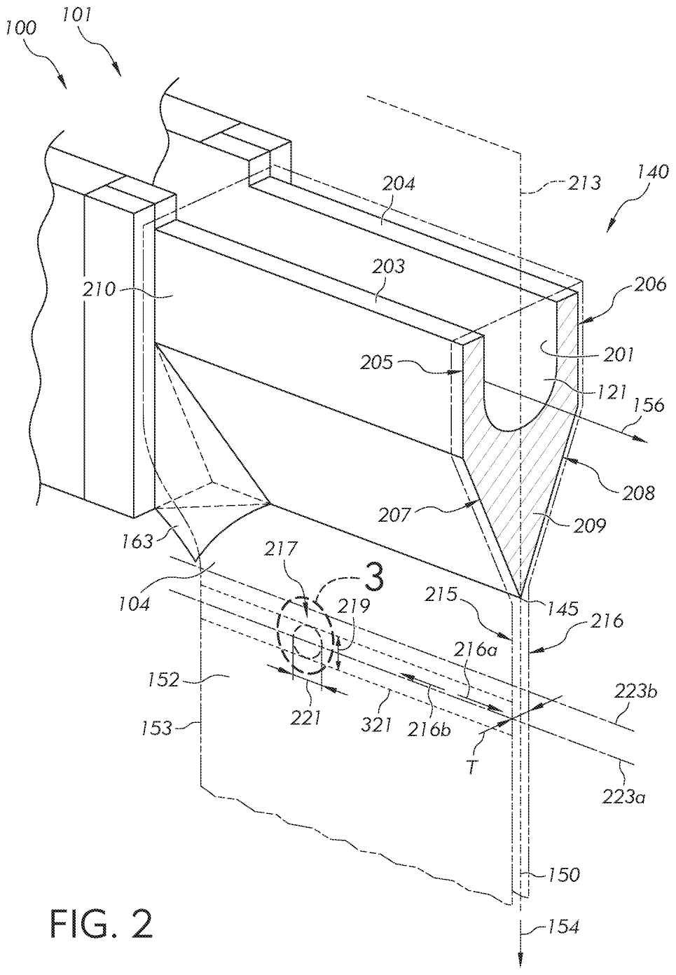

FIG. 2 shows a cross-sectional perspective view of the forming apparatus 101 (e.g., forming vessel 140) along line 2-2 of FIG. 1. In some embodiments, the forming vessel 140 can include a trough 201 oriented to receive the molten material 121 from the inlet conduit 141. For illustrative purposes, cross-hatching of the molten material 121 is removed from FIG. 2 for clarity. The forming vessel 140 can further include the forming wedge 209 including a pair of downwardly inclined converging surface portions 207, 208 extending between opposed ends 210, 211 (See FIG. 1) of the forming wedge 209. The pair of downwardly inclined converging surface portions 207, 208 of the forming wedge 209 can converge along the travel direction 154 to intersect along the root 145 of the forming vessel 140. A draw plane 213 of the glass manufacturing apparatus 100 can extend through the root 145 along the travel direction 154 of the travel path 150. In some embodiments, the molten portion 104 of the ribbon can move along the travel direction 154 of the travel path 150 and through the draw plane 213. As shown, the draw plane 213 can bisect the forming wedge 209 through the root 145 although, in some embodiments, the draw plane 213 can extend at other orientations relative to the root 145.

Additionally, in some embodiments, the molten material 121 can flow in a direction 156 into and along the trough 201 of the forming vessel 140. The molten material 121 can then overflow from the trough 201 by simultaneously flowing over corresponding weirs 203, 204 and downward over the outer surfaces 205, 206 of the corresponding weirs 203, 204. Respective streams of molten material 121 can then flow along the downwardly inclined converging surface portions 207, 208 of the forming wedge 209 to be drawn off the root 145 of the forming vessel 140, where the flows converge and fuse into the molten portion 104 of the ribbon. The molten portion 104 of the ribbon can then be drawn off the root 145 in the draw plane 213 and the ribbon can move along the travel direction 154 of the travel path 150 and cooled into the glass portion 103 of the ribbon.

The molten portion 104 of the ribbon comprises a first major surface 215 and a second major surface 216 facing opposite directions and defining a thickness “T” (e.g., average thickness) of the molten portion 104. In some embodiments, the thickness “T” of the molten portion 104 of the ribbon can be from about 0.5 millimeters (mm) to about 5 mm although other thicknesses can be provided in further embodiments. The thickness of the ribbon attenuates as it moves in the travel direction 154 of the travel path 150 and cools to transition from the molten portion 104 to the glass portion 103 of the ribbon. The final thickness of the glass portion 103 of the ribbon can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further embodiments. For example, in some embodiments, the thickness of the glass portion 103 can be from about 50 μm to about 750 μm, from about 100 μm to about 700 μm, from about 200 μm to about 600 μm, from about 300 μm to about 500 μm, from about 50 μm to about 500 μm, from about 50 μm to about 700 μm, from about 50 μm to about 600 μm, from about 50 μm to about 500 μm, from about 50 μm to about 400 μm, from about 50 μm to about 300 μm, from about 50 μm to about 200 μm, from about 50 μm to about 100 μm, including all ranges and subranges of thicknesses therebetween. In addition, the glass portion 103 of the ribbon can include a variety of compositions including, but not limited to, soda-lime glass, borosilicate glass, alumino-borosilicate glass, alkali-containing glass, or alkali-free glass.

The separated glass ribbon can then be processed into a desired application, e.g., a display application. For example, the separated glass ribbon can be used in a wide range of display applications, including liquid crystal displays (LCDs), electrophoretic displays (EPD), organic light emitting diode (OLED) displays, plasma display panels (PDPs), and other electronic displays.

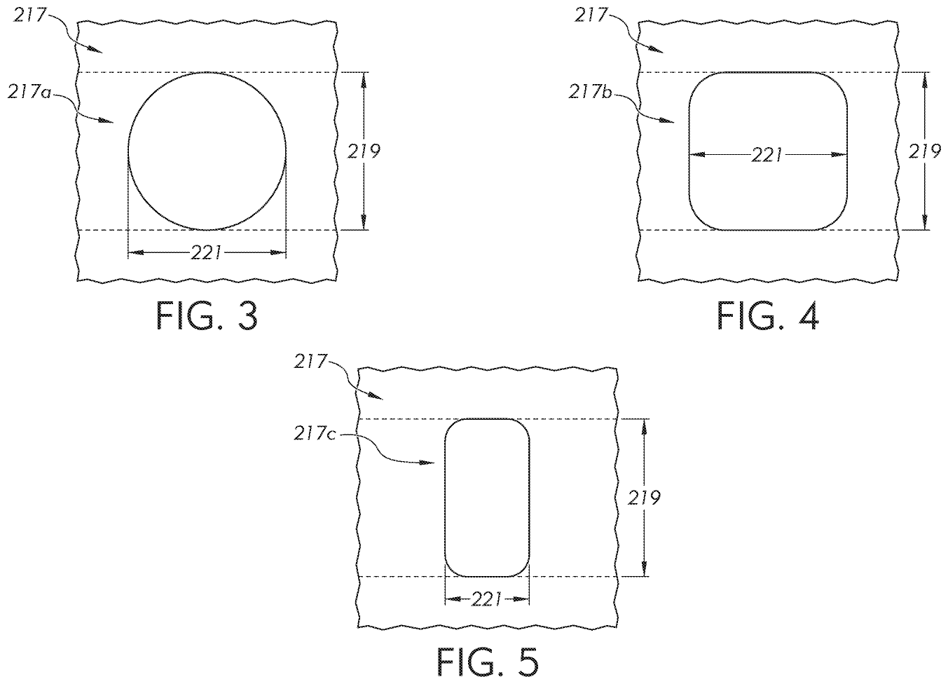

FIGS. 3-4 illustrate features of example embodiments of the treatment apparatus 142 of the glass manufacturing apparatus 100 for treating the molten portion 104 of the ribbon. The treatment apparatus 142 can comprise a laser generator 301 designed to produce a pulsed laser beam 303. In some embodiments, the laser generator can be designed to produce the pulsed laser beam 303 that can be absorbed by the molten portion 104 of the ribbon to heat the molten portion 104 of the ribbon at the location where the pulsed laser beam 303 impinges the surface of the molten portion 104 of the ribbon. In some embodiments, the laser generator 301 can comprise a CO₂ laser generator although other types of laser generators may be used in further embodiments. In addition or alternatively, in some embodiments, the pulsed laser beam 303 produced by the laser generator 301 can comprise a wavelength in a range from about 0.9 micrometers to about 12 micrometers.

The treatment apparatus 142 can further include a deflector device configured to deflect the pulsed laser beam 303 to impinge the deflected pulsed laser beam 303 on a heating zone of the molten portion 104 of the ribbon. As shown in FIG. 2, the deflected laser beam can impinge on a heating zone 217 on a treatment path 321 of the molten portion 104 while the heating zone 217 travels along direction 216a. For example, the heating zone 217 can travel across substantially the entire width “W” in direction 216a from the first outer edge 153 to the second outer edge 155. After reaching the second outer edge 155, the heating zone may reappear at the first outer edge 153 and again travel in the direction 216a to the second outer edge 155. Consequently, in some embodiments, the heating zone 217 can travel in the same direction 216a for each pass of the heating zone 217 across the width “W” of the ribbon from the first outer edge 153 to the second outer edge 155.

As shown in FIG. 2, the deflected laser beam can impinge on the heating zone 217 on the treatment path 321 of the molten portion 104 while the heating zone 217 travels along direction 216b. For example, the heating zone 217 can travel across substantially the entire width “W” in direction 216b from the second outer edge 155 to the first outer edge 153. After reaching the first outer edge 153, the heating zone may reappear at the second outer edge 156 and again travel in the direction 216b to the first outer edge 153. Consequently, in some embodiments, the heating zone 217 can travel in the same direction 216b for each pass of the heating zone 217 across the width “W” of the ribbon from the second outer edge 155 to the first outer edge 153.

As further shown in FIG. 2, the deflected laser beam can impinge on the heating zone 217 on the treatment path 321 of the molten portion 104 while the heating zone 217 travels along the direction 216a and the direction 216b. For example, in some embodiments, the heating zone 217 can travel across substantially the entire width “W” in the direction 216a from the first outer edge 153 to the second outer edge 155. After reaching the second outer edge 155, the heating zone 217 can then travel across substantially the entire width “W” in the direction 216b from the second outer edge 155 to the first outer edge 153. Consequently, in some embodiments, the heating zone 217 can travel in alternating directions 216a and 216b for each successive pass across the width “W” of the ribbon.

One or both of the directions 216a and 216b can extend across the travel direction 154 of the travel path 150. For example, as shown, one or both of the directions 216a and 216b can extend perpendicular to the travel direction 154 along the direction of the width “W” although heating zone may travel along directions that are not perpendicular to the travel direction 154 in further embodiments. Various deflector devices can be used to cause the heating zone 217 to travel in one or both of the directions 216a and 216b as discussed above. For example, in some embodiments, the deflector device can comprise an acoustic optical deflector. In another example, in some embodiments, the deflector device can comprise an electro-optic deflector. In still another example, in some embodiments, the deflector device can comprise a rotating reflective surface.

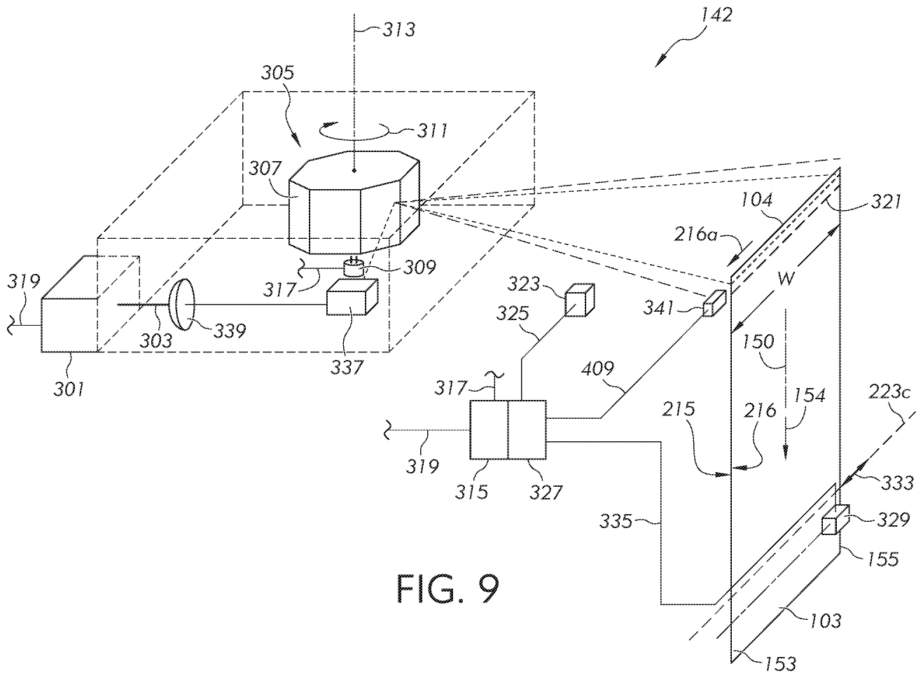

In some embodiments, as shown in FIG. 9, the deflector device can comprise a polygonal reflecting device 305 including a plurality of reflective surfaces 307. As shown, the polygonal reflecting device 305 may be rotated by a motor 309 to rotate in a rotation direction 311 about a rotation axis 313 of the polygonal reflecting device 305. In some embodiments, the motor 309 may optionally be operated by a control device 315 (e.g., programmable logic controller) configured to (e.g., “programmed to”, “encoded to”, “designed to”, and/or “made to”) send command signals along communication line 317 to the motor 309 to rotate, in some embodiments, at a substantially constant angular velocity about the rotation axis 313 of the polygonal reflecting device 305. Rotating the polygonal reflecting device 305 at a substantially constant angular velocity can help prevent damage to the motor 309 that may otherwise occur by frequently changing the angular velocity of the polygonal reflecting device 305. In embodiments where the pulsed laser beam is reflected by the polygonal reflecting device 305, the heating zone 217 may repeatedly travel in direction 216a or repeatedly travel in direction 216b depending on the rotation direction 311 that the polygonal reflecting device 305 rotates about the rotation axis 313.

The control device 315 may be configured to (e.g., “programmed to”, “encoded to”, “designed to”, and/or “made to”) send command signals (e.g., by way of communication line 319) to the laser generator 301 to control a characteristic of the pulsed laser beam 303 to selectively control the heating of a location of a nonuniformity of the molten portion 104 of the ribbon. In some embodiments, the control device 315 may control a pulse frequency of the pulsed laser beam 303 to control the heating of the location of nonuniformity of the molten portion 104 of the ribbon. In some embodiments, the control device 315 may control a pulse width of the pulsed laser beam 303 to control the heating of the location of nonuniformity of the molten portion 104 of the ribbon. In some embodiments, the control device 315 may control a duty cycle of the pulsed laser beam 303 to control the heating of the location of nonuniformity of the molten portion 104 of the ribbon. In some embodiments, the control device 315 may control a plurality of characteristics of the pulsed laser beam 303 to control the heating of the location of nonuniformity of the molten portion 104 of the ribbon. For example, in some embodiments, the control device 315 may control the pulse frequency and the pulse width of the pulsed laser beam 303 to control the heating of the location of nonuniformity of the molten portion 104 of the ribbon. In some embodiments, the control device 315 may control the pulse frequency and the duty cycle of the pulsed laser beam 303 to control the heating of the location of nonuniformity of molten portion 104 of the ribbon. In some embodiments, the control device 315 may control the pulse width and the duty cycle of the pulsed laser beam 303 to control the heating of the location of nonuniformity of the molten portion 104 of the ribbon. In some embodiments, the control device 315 may control two or more of the pulse frequency, the pulse width and the duty cycle of the pulsed laser beam 303 to control the heating of the location of nonuniformity of molten portion 104 of the ribbon.

Further referring to FIG. 9, the treatment apparatus 142 can further comprise one or more sensing devices configured to monitor a characteristic of the ribbon. In some embodiments, the monitored characteristic of the ribbon can comprise a temperature and/or a thickness of the ribbon. In some embodiments, the one or more sensing devices can directly monitor a characteristic of the molten portion 104 of the ribbon. For example, with reference to FIG. 2, the characteristic of the molten portion 104 of the ribbon along a monitoring path 223a within the treatment path 321 may be directly monitored. In further embodiments, the characteristic of the molten portion 104 of the ribbon along a monitoring path 223b outside of the treatment path 321 (e.g., upstream or downstream from the treatment path 321) may be directly monitored. In some embodiments, a characteristic of the molten portion 104 of the ribbon within the treatment path 321 may be indirectly monitored. For example, as shown in FIG. 9, the characteristic of the glass portion 103 of the ribbon along a monitoring path 223c downstream from the molten portion 104 of the ribbon may be monitored. Then a corresponding characteristic of the molten portion 104 of the ribbon within the treatment path 321 may be determined based on the monitored characteristic along the monitoring path 223c of the glass portion 103. For instance, a nonuniformity in the characteristic monitored along the monitoring path 223c of the glass portion 103 may indicate a corresponding nonuniformity in the characteristic of a portion of the treatment path 321 of the molten portion 104 of the ribbon located vertically above the monitored nonuniformity in the characteristic monitored along the monitoring path 223c of the glass portion 103.

As shown in FIG. 9, the treatment apparatus 142 may optionally include a temperature sensor 323 configured to monitor the temperature of the molten portion 104 of the ribbon along a monitoring path (e.g., monitoring path 223a, 223b). In some embodiments, the temperature sensor 323 can comprise an infrared sensor (e.g., infrared camera) configured to monitor the temperature of the molten portion 104 by monitoring the infrared radiation being emitted by the molten portion 104 of the ribbon along one of the monitoring paths (e.g., 223a, 223b). For instance, the temperature sensor 323 can comprise an infrared sensor (e.g., infrared camera) configured to directly monitor the temperature of the treatment path 321 of the molten portion 104 along the monitoring path 223a. Sensed information relating to the temperature of the molten portion 104 of the ribbon along the monitoring path may then be transmitted by communication line 325 to a processor 327. The processor 327 can then process the information to determine one or more locations of nonuniformity of the temperature of the molten portion 104 of the ribbon on the treatment path 321. Based on the information from the processor 327, the control device 315 may be configured to (e.g., “programmed to”, “encoded to”, “designed to”, and/or “made to”) modify the heating of the location of molten portion 104 of the ribbon to cause the nonuniformity to dissipate to provide a more uniform thickness of the molten portion 104 of the ribbon across the width “W” of the molten portion 104 of the ribbon. For example, a nonuniformity can be dissipated such that the thickness variation is less than 3 micrometers. Once the more uniform thickness is achieved, the molten portion 104 of the ribbon can proceed to be cooled into the glass portion 103 of the ribbon with a more uniform thickness of the glass portion 103 along the width “W” of the glass portion 103 of the ribbon.

In one embodiment, if the nonuniformity is determined to be a relatively low temperature compared to other locations of the monitoring path, the control device 315 may be configured to (e.g., “programmed to”, “encoded to”, “designed to”, and/or “made to”) send command signals by way of the communication line 319 to the laser generator 301 to increase the heating of the location(s) of the nonuniformity by increasing one or more of the pulse frequency, the pulse width, or duty cycle as discussed above while the pulsed laser beam 303 heats the location(s) of the nonuniformity.

In another embodiment, if the nonuniformity is determined to be a relatively high temperature compared to other locations of the monitoring path, the control device 315 may be configured to (e.g., “programmed to”, “encoded to”, “designed to”, and/or “made to”) send command signals by way of the communication line 319 to the laser generator 301 to decrease the heating of the location(s) of the nonuniformity by decreasing one or more of the pulse frequency, the pulse width or duty cycle as discussed above while the pulsed laser beam 303 heats the location(s) of the nonuniformity.

As further shown in FIG. 9, the treatment apparatus 142 may optionally include a thickness sensor 329 configured to sense information relating to a thickness of the ribbon. In some embodiments, the thickness sensor 329 may be provided without the temperature sensor 323. In further embodiments, the temperature sensor 323 may be provided without the thickness sensor 329. In further embodiments, the thickness sensor 329 and the temperature sensor 323 may both be provided to monitor one or more characteristics of the ribbon. If provided, the thickness sensor 329 can comprise an optical thickness sensor. The optical thickness sensor can comprise one or more sensors spanning across the width “W” of the ribbon. Alternatively, as shown, the optical thickness sensor 329 can be configured to scan in directions 333 across the travel direction 154 of the travel path 150. For example, as shown, the thickness sensor 329 can be configured to scan in directions 333 perpendicular to the travel direction 154 although other scanning directions may be provided in further embodiments. In some embodiments, the optical thickness sensor 329 can include a laser that directs a laser beam to a location of a monitoring path (e.g., monitoring path 223c of the glass portion 103). A portion of the laser beam can reflect from the second major surface 216 to be sensed by the optical thickness sensor 329. Another portion of the laser beam can pass through the thickness of the ribbon and then be reflected off the first major surface 215 back to be sensed by the optical thickness sensor 329. The information regarding the reflected portions of the laser beam can be transmitted by way of communication line 335 to the processor 327. The processor can then consider this information together with the refractive index of the ribbon to calculate the thickness of the ribbon along a monitoring path and/or calculate the thickness of the ribbon along the treatment path 321. For example, as shown in FIG. 9, the thickness sensor 329 can sense the thickness of a glass portion 103 along monitoring path 223c. The processor 327 can then process the information to determine a location of a nonuniformity in thickness sensed along the monitoring path 223c. The sensed nonuniformity can be used by the processor to determine a corresponding location of a nonuniformity in a thickness of a corresponding portion of the molten portion 104 of the ribbon within the treatment path 321 that may be located vertically above the sensed nonuniformity in the glass portion 103. Based on the information from the processor 327, the control device 315 may be configured to (e.g., “programmed to”, “encoded to”, “designed to”, and/or “made to”) modify the heating of the location of the nonuniformity to cause the nonuniformity to dissipate to provide a more uniform thickness of the molten portion 104 across the width “W” of the molten portion 104 of the ribbon. Once the more uniform thickness is achieved, the molten portion 104 of the ribbon can proceed to be cooled into the glass portion 103 with a more uniform thickness of the glass portion 103 along the width “W” of the glass portion 103 of the ribbon.

In one embodiment, if the nonuniformity of thickness is determined to be a relatively high thickness compared to other locations of the treatment path 321, the control device 315 may be configured to (e.g., “programmed to”, “encoded to”, “designed to”, and/or “made to”) send command signals by way of the communication line 319 to the laser generator 301 to increase the heating of the location(s) of the nonuniformity of thickness by increasing one or more of the pulse frequency, the pulse width or duty cycle as discussed above while the pulsed laser beam 303 heats the location(s) of the nonuniformity of thickness. The increased heating can reduce the viscosity of the molten material at the location(s) of the nonuniformity to reduce the thickness of the molten portion 104 of the ribbon at the location(s) of the nonuniformity of thickness.

In another embodiment, if the nonuniformity of thickness is determined to be a relatively low thickness compared to other locations of the treatment path 321, the control device 315 may be configured to (e.g., “programmed to”, “encoded to”, “designed to”, and/or “made to”) send command signals by way of the communication line 319 to the laser generator 301 to decrease the heating of the location(s) of the nonuniformity of thickness by decreasing one or more of the pulse frequency, the pulse width or duty cycle as discussed above while the pulsed laser beam 303 heats the location(s) of the nonuniformity of thickness. The decreased heating can increase the viscosity of the molten material at the location(s) of the nonuniformity of thickness to increase the thickness of the molten portion 104 of the ribbon at the location(s) of the nonuniformity of thickness.

The deflected pulsed laser may impinge on the first major surface 215 of the molten portion 104 of the ribbon at one of various alternative heating zones 217 as schematically shown in FIG. 2. FIG. 3 illustrates one embodiment where the heating zone 217 comprises a circular heating zone 217a. FIG. 4 illustrates another embodiment of the heating zone 217 comprising a square heating zone 217b with rounded corners.

In some embodiments, the heating zone can be elongated in the travel direction 154 of the travel path 150 wherein the heating zone includes a length 219 extending in the travel direction 154 that is greater than a width 221 of the heating zone that extends perpendicular to the travel direction 154. Providing the length 219 extending in the travel direction 154 that is greater than the width 221 can increase the time that the location of the nonuniformity is heated as the molten portion 104 of the ribbon travels in the travel direction 154; thereby allowing more time for heat to conduct through the thickness “T” [e.g., from about 0.5 millimeters (mm) to about 5 mm] of the molten portion 104 of the ribbon that is traveling in the travel direction 154. In some embodiments, a ratio of the length 219 of the heating zone to the width 221 of the heating zone can be about 3 or more. In some embodiments, in addition or alternatively to the above-referenced ratio of the length to width of 3 or more, the width 221 of the heating zone that extends perpendicular to the travel direction 154 can be in a range from about 100 micrometers to about 30 millimeters (mm). In some embodiments, in addition or alternatively to the above-referenced ratio of the length to width of 3 or more, the length 219 of the heating zone along the travel path 150 can be in a range from about 1 mm to about 100 mm. In some embodiments, the method can comprise selectively controlling the length 219 of the pulsed laser beam. For example, in some embodiments, the control device 315 may be configured to (e.g., “programmed to”, “encoded to”, “designed to”, and/or “made to”) selectively control the length 219 of the heating zone based on the speed that the molten portion 104 of the ribbon is traveling in the travel direction 154.

In some embodiments, the heating zone can comprise an oblong shape such the length 219 extending in the travel direction 154 that is greater than the width extending perpendicular to the travel direction 154. FIG. 5 illustrates another embodiment of the heating zone 217 comprising an oblong shape in the form of a rectangular heating zone 217c with rounded corners.

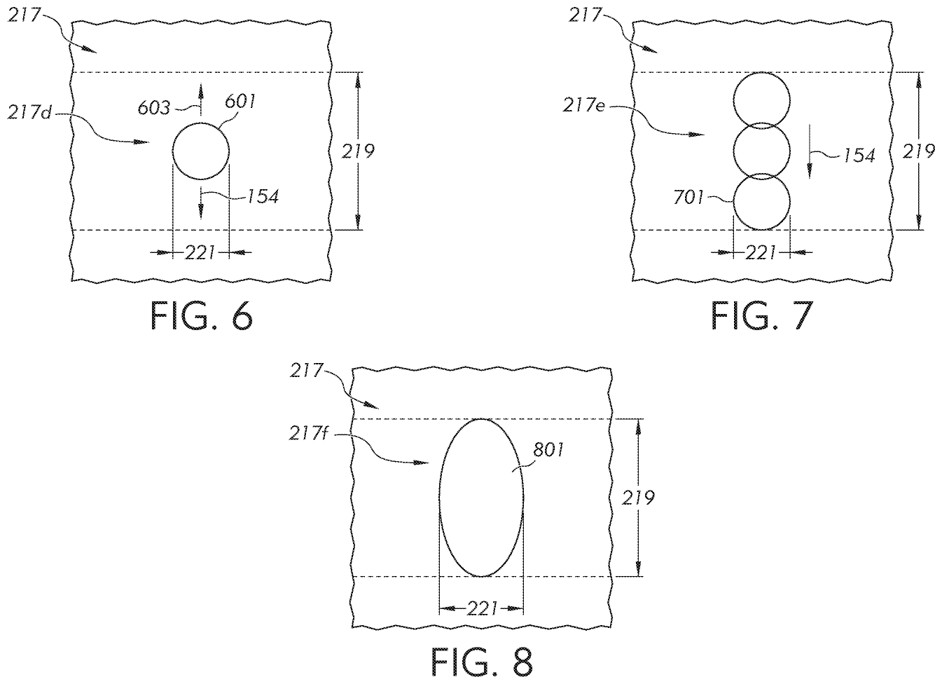

FIG. 6 illustrates another embodiment of the heating zone 217 comprising a reciprocating beam spot 601 that produces an oblong heating zone 217d. In some embodiments, the pulsed laser beam 303 can be moved to repeatedly move the beam spot 601 in the travel direction 154 of the travel path 150 to produce the oblong heating zone 217d. In some embodiments, the pulsed laser beam 303 can be moved to repeatedly move the beam spot 218 in a direction 603 opposite travel direction 154 of the travel path 150 to produce the oblong heating zone 217d. Alternatively, in some embodiments, the pulsed laser beam 303 can be moved to repeatedly reciprocate the beam spot 601 in the travel direction 154 and in the direction 603 opposite the travel direction 154 to produce the oblong heating zone 217d. For example, the beam spot 601 can oscillate up in direction 603 and down in direction 154 to create the oblong heating zone 217d. The oblong heating zone 217d provided by the moving beam spot 218 can include the length 219 extending in the travel direction 154 that is greater than the width 221 that extends perpendicular to the travel direction 154. As shown schematically in FIG. 9, the treatment apparatus 142 may include a heating zone device 337 to modify the pulsed laser beam 303 produced by the laser generator 301 to create the heating zone including the length that is greater than the width. For instance, the heating zone device 337 can comprise an oscillator that causes the beam spot 601 to travel along one or more of directions 154 or 603. In some embodiments, the oscillator can comprise a rotating mirror or other moving mirrors or moving optical components to cause the beam spot to quickly and repeatedly travel along the direction(s) to produce the oblong heating zone 217d.

In some embodiments, as shown in FIG. 7, the heating zone 217 may comprise an oblong heating zone 217e provided by a plurality of pulsed laser beams impinging on the oblong heating zone 217e as an array of beam spots 701. As shown, in some embodiments, the centers of the beam spots 701 can each be positioned on a linear axis that extends in the travel direction 154. For instance, as shown in FIG. 2, the array of beam spots 701 comprises three beam spots with centers positioned on a linear axis that extends in the travel direction 154 to provide the oblong heating zone 217e with the length 219 extending in the travel direction 154 that is greater than the width 221 that extends perpendicular to the travel direction 154. While three beam spots 701 are illustrated, in some embodiments two beam spots or more than three beam spots may be provided. Furthermore, the plurality of beam spots 701 may overlap one another although the beam spots may be slightly spaced apart in further embodiments. Overlapping the beam spots can create a more uniform heating along the length 219. If providing the beam spots 701 in an overlapping aligned configuration, some embodiments may overlap the beam spots by 50% or less of the dimension of the beam spot 701 in the travel direction 154. In some embodiments, the heating zone device 337 can comprise a beam splitter designed to split the pulsed laser beam 303 from the laser generator 301 into the plurality of pulsed laser beams that impinge on the major surface of the molten portion 104 of the ribbon in the above-described array of beam spots.

In some embodiments, as shown in FIG. 8, the heating zone 217 may comprise an oblong heating zone 217f provided as a beam spot 801 in the shape of an ellipse. As shown, the beam spot 801 of oblong heating zone 217f impinged by the pulsed laser beam 303 in the illustrated elliptical shape can comprise a major axis extending in the travel direction 154 of the travel path 150 such that the length 219 of the heating zone extends in the travel direction 154 of the travel path 150 and is greater than the width 221 that extends perpendicular to the travel direction 154. Referring to FIG. 9, in some embodiments, an optical component 339 may be provided to shape the pulsed laser beam 303 and provide the oblong heating zone 217f in the shape of an ellipse. In some embodiments, the optical component 339 may comprise one or more cylindrical lenses. In some embodiments, the optical component 339 may comprise an anamorphic prism.

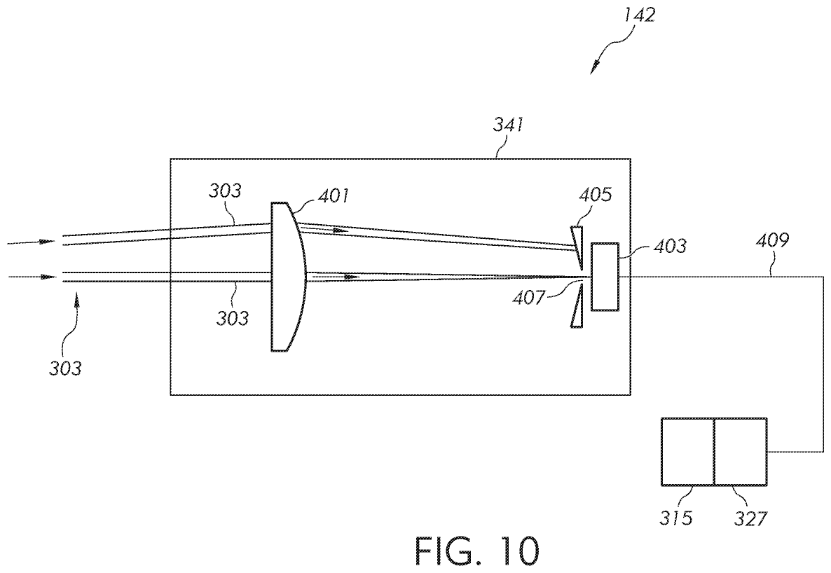

As shown in FIGS. 9-10, the treatment apparatus 142 can optionally comprise a sensing apparatus 341. FIG. 10 schematically shows embodiments of the sensing apparatus 341 comprising a sensing device 403. In some embodiments, laser generator 301 can be configured to emit a pulsed laser beam 303 to be deflected with the deflector device (e.g., polygonal reflecting device) to impinge on the sensing device 403. The pulsed laser beam 303 impinging on the sensing device 403 can generate a signal that may be communicated to the processor 327 by way of communication line 409. The processor can then calibrate the location of the deflected pulsed laser beam 303 to allow more accurate and precise heating of the proper location of nonuniformity in the characteristic of the molten portion 104 of the ribbon.

Methods of manufacturing a ribbon will now be discussed with reference to FIGS. 2-10. Embodiments of methods of manufacturing the ribbon can comprise moving the ribbon along the travel direction 154 of the travel path 150. For example, the ribbon may be fusion drawn from the root 145 of the forming vessel 140 to draw the ribbon along the travel direction 154 of the travel path 150. Methods of the disclosure can further include identifying a location of a nonuniformity in a characteristic (e.g., temperature and/or thickness) of the ribbon such as the molten portion 104 of the ribbon. In some embodiments, methods may include monitoring the characteristic of the molten portion 104 of the ribbon along a monitoring path 223a, 223b, 223c to directly or indirectly identify the location of the nonuniformity in the characteristic (e.g., temperature, thickness) of the molten portion 104 of the ribbon.

In one embodiment, the method may include identifying the location of a nonuniformity in the temperature of the molten portion 104 of the ribbon. In some embodiments, the temperature may be monitored by the temperature sensor 323 (e.g., infrared camera). In some embodiments, the temperature sensor 323 may monitor the temperature of the molten portion 104 of the ribbon along a monitoring path 223a, 223b of the molten portion 104. Signals relating to the sensed temperature can be communicated by way of the communication line 325 to the processor 327 that can determine one or more locations of a nonuniformity in the temperature along the monitoring path.

In another embodiment, the method may include identifying the location of the nonuniformity in the thickness of the ribbon (e.g., a thickness of the glass portion 103 and/or the molten portion 104 of the ribbon). In some embodiments, the thickness may be monitored by the thickness sensor 329 along the monitoring path 223c of the glass portion 103 of the ribbon. Signals relating to the sensed thickness can be communicated by way of the communication line 335 to the processor 327 that can determine one or more locations of a nonuniformity in the thickness of the glass portion 103 and/or the molten portion 104 located vertically above the glass portion 103.

Methods of the disclosure can further comprise heating the molten portion 104 of the ribbon. In some embodiments, the pulsed laser beam 303 may be generated by the laser generator 301. The laser generator 301 produces a pulsed laser beam that can impinge on a surface of the molten portion 104 of the ribbon to transfer energy from the pulsed laser beam 303 to the molten portion 104. In some embodiments, a CO₂ laser generator may be used to produce the pulsed laser beam 303, although other types of laser generators may be used in further embodiments. In some embodiments, the pulsed laser beam 303 may comprise a wavelength that can facilitate transfer of energy from the pulsed laser beam 303 to the molten portion 104 when the pulsed laser beam 303 impinges on the surface of the molten portion 104. For instance, the pulsed laser beam can include a wavelength within a range of from about 0.9 micrometers to about 12 micrometers to allow the energy from the pulsed laser beam 303 to be absorbed by the molten portion 104 of the ribbon. The wavelength of the pulsed laser beam can be selected to optimize absorption on the particular type of molten material being treated.

The treatment apparatus 142 may then deflect the pulsed laser beam 303 to impinge on the treatment path 321 at the heating zone 217 on the treatment path 321 of the molten portion 104 of the ribbon. In some embodiments, as shown, the treatment path 321 can extend perpendicular to the travel direction 154 although the treatment path 321 may extend at other angles in further embodiments. Deflection of the pulsed laser beam 303 can be achieved using an acoustic optical deflector or an electro-optic deflector to deflect the generated pulsed laser beam 303. In still further embodiments, the deflection of the pulsed laser beam 303 may comprise reflecting the pulsed laser beam 303 off a reflective surface.

Deflection of the pulsed laser beam 303 can result in movement of the heating zone 217 along one of the directions 216a, 216b of the treatment path 321. In embodiments where the treatment path 321 is perpendicular to the travel direction 154, the directions 216a, 216b can comprise directions of the width “W” of the ribbon. Movement of the heating zone 217 along the directions 216a, 216b can be achieved by the acoustic optical deflector, the electro-optic deflector or the reflective surface. For instance, the reflective surface can comprise a rotating reflective surface such as a rotating mirror. The rotating mirror can rotate about an axis wherein the heating zone 217 moves along one or both of the directions 216a, 216b depending on how the reflective surface is rotated.

In the illustrated embodiment, the reflective surface, if provided, can comprise a plurality of reflective surfaces 307 of the polygonal reflective device 305. As shown, the plurality of reflective surfaces 307 can, in some embodiments, comprise a plurality of reflective flat mirrors that are radially arranged about the rotation axis 313 to define an outer polygonal peripheral shape of the polygonal reflective device 305. Consequently, as shown in FIG. 9, the pulsed laser beam 303 reflecting off each reflective surface 307 of the polygonal reflective device 305 can result in a stroke of the heating zone 217 along direction 216a across the width “W” of the ribbon as the polygonal reflective device 305 rotates in rotation direction 311 about the rotation axis 313.

In some embodiments, the method can comprise rotating the polygonal reflecting device at a substantially constant angular velocity in the rotation direction 311 about the rotation axis 313 of the polygonal reflecting device 305 to move the heating zone 217 along the treatment path 321. Rotating the polygonal reflecting device 305 at a substantially constant angular velocity can increase the lifespan of the motor 309 driving the rotation of the polygonal reflecting device 305 by avoiding overheating and other stresses that can cause premature failure of the motor 309 due to constant changes in the angular velocity that may otherwise be required to provide a desired heating profile across the treatment path 321.

Methods of the disclosure can comprise impinging the deflected (e.g., reflected) pulsed laser beam 303 on the heating zone 217 along the treatment path 321 wherein the heating zone 217 can comprise the identified location of the nonuniformity. For instance, as the heating zone 217 travels in the direction 216a and/or 216b of the treatment path 321, the heating zone can be moved such that, during a period of time, the heating zone comprises the identified location of nonuniformity. A characteristic of the pulsed laser beam 303 can be controlled to selectively control the heating provided by the pulsed laser beam 303 depending on the location of the heating zone 217 along the treatment path 321. For instance, controlling the characteristic of the pulsed laser beam 303 may comprise modifying one or more characteristics (e.g., pulse frequency, pulse width, and/or duty cycle) of the pulsed laser beam 303 for the period of time that the heating zone 217 comprises the identified location of nonuniformity. Modifying the one or more characteristics of the pulsed laser beam 303 can also allow selective adjustment of the heating of the molten portion 104 of the ribbon at the location of nonuniformity to treat the location of the nonuniformity different than other locations of the molten portion 104 along the treatment path 321. In some embodiments, selective controlling of the heating of the nonuniformity can cause the nonuniformity to dissipate where the thickness variation at the location of nonuniformity relative to the thickness of other locations along the treatment path 321 is less than 3 micrometers. In some embodiments, the pulsed laser beam 303 may be turned off along a portion of the treatment path 321. For example, the pulsed laser beam 303 may be turned of when the deflected pulsed laser beam 303 would not produce the heating zone 217 comprising the location of the nonuniformity. Rather, the pulsed laser beam 303 can be turned on only when the deflected pulsed laser beam 303 provides the heating zone 217 comprising the location of the nonuniformity. Turning off the pulsed laser beam 303 when the resulting beam spot would be located outside of the location of nonuniformity can avoid thinning portions of the ribbon outside of the location of the nonuniformity. Alternatively, the pulsed laser beam may be left on during a longer length of the treatment path 321 (e.g., across the entire width “W” of the ribbon) to change the amount of heating along the treatment path 321 wherein enhanced heating can be provided at the location of nonuniformity to cause relatively higher thinning at that location relative to locations outside of the nonuniformity to cause the nonuniformity to dissipate.

In one embodiment, if the nonuniformity comprises an overly thick location of the molten portion 104, the method can include changing one or more characteristics of the pulsed laser beam 303 to increase the heating with the pulsed laser beam 303 while the heating zone 217 comprises the identified location of nonuniformity. The increased heating can dissipate the nonuniformity of thickness of the molten portion along the treatment path 321.

In another embodiment, if the nonuniformity comprises a reduced temperature at the location of the molten portion 104, the method can include changing one or more characteristics of the pulsed laser beam 303 to increase the heating with the pulsed laser beam 303 while the heating zone 217 comprises the identified location of nonuniformity. The increased heating can cause the temperature nonuniformity to dissipate where the temperature becomes more uniform across the treatment path 321 and across the width “W” of the ribbon.

In another embodiment, if the nonuniformity comprises an elevated temperature at the location of the molten portion 104, the method can include changing one or more characteristics of the pulsed laser beam 303 to decrease the heating with the pulsed laser beam 303 while the heating zone 217 comprises the identified location of nonuniformity. The decreased heating can cause the temperature nonuniformity to dissipate where the temperature becomes more uniform across the treatment path 321 and across the width “W” of the ribbon.

In some embodiments, the polygonal reflecting device 305 may rotate at a substantially constant angular velocity while the characteristic of the pulsed laser beam 303 may be controlled to modify the heating profile across of the treatment path 321. In such a manner, rotation of the polygonal reflecting device 305 at the substantially constant angular velocity can avoid failure of the motor 309 while changing the characteristic of the pulsed laser beam 303 can provide a desired heating profile across the treatment path 321 as the polygonal reflecting device 305 rotates.

In some embodiments, the method can comprise impinging the pulsed laser beam 303 on a heating zone 217 that, as illustrated in FIG. 2, may be elongated in the travel direction 154 of the travel path 150 wherein the length 219 of the heating zone 217 extending in the travel direction 154 is greater than the width 221 of the heating zone 217 extending perpendicular to the travel direction 154. The heating zone may not be elongated in some embodiments, for example, with certain glass compositions or when the molten portion of the ribbon may be more responsive to heating through the entire thickness when the major surface of the ribbon is impinged by the pulsed laser beam. In some embodiments, providing the heating zone 217 that is elongated in the travel direction 154 can help increase the accumulated time that the location of the nonuniformity of the molten portion 104 of the ribbon is exposed to the pulsed laser beam 303 as the ribbon travels in the travel direction 154. The increase in accumulated time of exposure can help the pulsed laser beam 303 more fully heat the full thickness of the molten portion 104 of the ribbon at the location of the nonuniformity even though the ribbon is traveling in the travel direction 154. In some embodiments, a ratio of the elongated length 219 of the heating zone 217 to the width 221 of the heating zone 217 may be about 3 or more. In some embodiments, the width 221 the heating zone 217 can be in a range from about 100 micrometers to about 30 millimeters. In some embodiments, the length 219 of the heating zone 217 can be in a range from about 1 millimeter to about 100 millimeters. In some embodiments, the elongated length 219 of the heating zone 217 may be about a distance that the ribbon moves in a selected period of time in the travel direction 154. In some embodiments, the period of time may be at least about 1 second although less than 1 second may be provided in further embodiments. For instance, the control device 315 may be configured to (e.g., “programmed to”, “encoded to”, “designed to”, and/or “made to”) send command signals to the heating zone device 337 to adjust the length 219 of the heating zone 217 based on the speed that the ribbon is traveling. For example, the control device 315 may be configured to (e.g., “programmed to”, “encoded to”, “designed to”, and/or “made to”) send command signals to the heating zone device 337 to cause the length 219 to adjust to be the distance the ribbon travels over a programmed period of time.

Various methods can be used to provide the optionally elongated heating zone as illustrated by the alternative heating zones 217 shown in FIGS. 3-8. In some embodiments, as discussed with respect to FIGS. 5-8, the heating zone 217 may optionally comprise an oblong heating zone including a length 219 in the travel direction 154 that is greater than the width 221 perpendicular to the travel direction 154. For example, FIG. 5 illustrates the heating zone 217 comprising an oblong shape in the form of the rectangular heating zone 217c with rounded corners. In another example, as shown in FIG. 6 and described previously, the heating zone 217 comprising the reciprocating beam spot 601 that produces the oblong heating zone 217d. In another embodiment, as shown in FIG. 7 and described previously, the heating zone 217 may comprise the oblong heating zone 217e provided by a plurality of pulsed laser beams impinging on the oblong heating zone 217e as an array of beam spots 701. In still another embodiment, as shown in FIG. 8 and described previously, the heating zone 217 may comprise the oblong heating zone 217f provided as the beam spot 801 in the shape of an ellipse.

In some embodiments, methods can include calibrating the location of the deflected laser beam to more accurately control the heating of the location of the nonuniformity. By frequently calibrating the location of the deflected laser beam, the processor 327 can more accurately control the characteristic of the pulsed laser beam at the appropriate time to provide the desired heating of the heating zone 217 comprising the identified location of the nonuniformity in the molten portion 104 of the ribbon. To facilitate calibration, in some embodiments, the treatment apparatus 142 can comprise a sensing apparatus 341 schematically illustrated in FIG. 9. Features of one embodiment of the sensing apparatus 341 is shown in FIG. 10. As shown, the sensing apparatus 341 can optionally comprise a focusing lens 401 designed to focus the pulsed laser beam 303. In further embodiments, the sensing apparatus 341 can comprise a mask 405 with an aperture 407. As shown, as the pulsed laser beam approaches the aperture 407 in the mask 405, the mask 405 blocks the pulsed laser beam 303 from passing through the mask 405 to reach the sensing device 403. However, eventually, the pulsed laser beam 303 moves to a position that is aligned with the aperture 407 of the mask, wherein the pulsed laser beam 303 can pass through the aperture 407 to impinge on the sensing device 403. The aperture 407 in the mask 405 can be reduced in size to increase the accuracy of locating the position of the pulsed laser beam at a particular time. Impinging the sensing device 403 with the pulsed laser beam 303 generates a signal that passes along communication line 409 to the processor 327 that then calibrates the precise location of the deflected pulsed laser beam based on the signal from the sensing device.

In some embodiments with a rotating polygonal reflecting device 305, the method can include reflecting the pulsed laser beam 303 off a reflective surface 307 of the polygonal reflecting device 305 to impinge on the molten portion 104 of the ribbon at a first angular orientation of the polygonal reflecting device and further reflect the pulsed laser beam 303 off the reflective surface 307 of the polygonal reflecting device 305 to impinge on the sensing device 403 at a second angular orientation different than the first angular orientation to calibrate the location of the reflected pulsed laser beam 303, for example, at least once for each stroke of the heating zone traveling across the width “W” of the ribbon. For example, as shown in FIG. 9, the reflected pulsed laser beam may move such that the heating zone travels along direction 216a along the treatment path 321 across the width “W” until the heating zone reaches the first outer edge 153 of the ribbon. Further rotation of the polygonal reflecting device 305 in rotation direction 311 causes the laser beam to travel off the first outer edge 153 and laterally outside the first outer edge 153 to eventually impinge on the sensing device 403 laterally outside the first outer edge 153. As such, the calibration of the location of the pulsed laser beam 303 can be conducted without interfering with the heating of the molten portion 104 of the ribbon along the treatment path 321 since unused portions of the pulsed laser beam that has travelled outside the first outer edge 153 may be used to calibrate the location of the pulsed laser beam 303. Although not shown, another sensing apparatus (similar or identical to the sensing apparatus 341) may be provided laterally outside the second outer edge 155. In such embodiments, calibration of the pulsed laser beam 303 may be conducted twice for each stroke of the heating zone traveling across the width “W” of the ribbon to further increase precision of calibration of the location of the pulsed laser beam 303.

Embodiments and the functional operations described herein can be implemented in digital electronic circuitry, or in computer software, firmware, or hardware, including the structures disclosed in this specification and their structural equivalents, or in combinations of one or more of them. Embodiments described herein can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “processor”, “controller” or “control device” can encompass all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes described herein can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit) to name a few.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), to name just a few.

Computer-readable media suitable for storing computer program instructions and data include all forms of data memory including nonvolatile memory, media and memory devices, including by way of example semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by, or incorporated in, special purpose logic circuitry.

To provide for interaction with a user, embodiments described herein can be implemented on a computer having a display device, e.g., a CRT (cathode ray tube) or LCD (liquid crystal display) monitor, and the like for displaying information to the user and a keyboard and a pointing device, e.g., a mouse or a trackball, or a touch screen by which the user can provide input to the computer. Other kinds of devices can be used to provide for interaction with a user as well; for example, input from the user can be received in any form, including acoustic, speech, or tactile input.

Embodiments described herein can be implemented in a computing system that includes a back-end component, e.g., as a data server, or that includes a middleware component, e.g., an application server, or that includes a front-end component, e.g., a client computer having a graphical user interface or a Web browser through which a user can interact with implementations of the subject matter described herein, or any combination of one or more such back-end, middleware, or front-end components. The components of the system can be interconnected by any form or medium of digital data communication, e.g., a communication network. Embodiments of communication networks include a local area network (“LAN”) and a wide area network (“WAN”), e.g., the Internet.

The computing system can include clients and servers. A client and server are generally remote from each other and typically interact through a communication network. The relationship of client and server arises from computer programs running on the respective computers and having a client-server relationship to each other.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Likewise, a “plurality” is intended to denote “more than one.”

Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

It should be understood that while various embodiments have been described in detail with respect to certain illustrative and specific embodiments thereof, the present disclosure should not be considered limited to such, as numerous modifications and combinations of the disclosed features are possible without departing from the scope of the following claims.

What is claimed is:

1. A method of manufacturing a ribbon comprising:
moving the ribbon along a travel direction of a travel path;
identifying a location of a nonuniformity in a characteristic of a molten portion of the ribbon;
deflecting a pulsed laser beam; and
impinging the deflected pulsed laser beam on a heating zone comprising the location of the nonuniformity, wherein the heating zone is elongated in the travel direction of the travel path.

2. The method of claim 1, wherein the deflecting the pulsed laser beam comprises reflecting the pulsed laser beam off a reflective surface of a polygonal reflecting device.

3. A method of manufacturing a ribbon comprising:
moving the ribbon along a travel direction of a travel path;
identifying a location of a nonuniformity in a characteristic of a molten portion of the ribbon on a treatment path of the molten portion of the ribbon;
reflecting a pulsed laser beam off a reflective surface of a polygonal reflecting device, the reflected pulsed laser beam impinging on a heating zone on the treatment path; and
rotating the polygonal reflecting device at a substantially constant angular velocity about a rotation axis of the polygonal reflecting device to move the heating zone along the treatment path, the heating zone comprising the location of the nonuniformity.

4. A method of manufacturing a ribbon comprising:
moving the ribbon along a travel direction of a travel path;
identifying a location of a nonuniformity in a characteristic of a molten portion of the ribbon;
deflecting a pulsed laser beam;
impinging the deflected pulsed laser beam on a heating zone comprising the location of the nonuniformity;
impinging the deflected pulsed laser beam on a sensing device, the impinging on the sensing device generating a signal; and
calibrating a location of the deflected pulsed laser beam based on the generated signal.

5. The method of claim 4, wherein the characteristic comprises a thickness of the ribbon.

6. The method of claim 4, wherein the characteristic comprises a temperature of the ribbon.

7. The method of claim 4, wherein the deflected pulsed laser beam impinges on the heating zone at a beam spot that is repeatedly moved within the heating zone along the travel path.

8. The method of claim 4, wherein the deflected pulsed laser beam comprises a plurality of deflected pulsed laser beams impinging on the heating zone at corresponding beam spots arranged as an array of beam spots aligned in the travel direction of the travel path.

9. The method of claim 4, wherein the heating zone comprises an elliptical shape comprising a major axis extending in the travel direction of the travel path.

10. The method of claim 4, wherein the method further comprises controlling a characteristic of the pulsed laser beam to control a heating of the location of the nonuniformity.

11. The method of claim 10, wherein the heating the location of the nonuniformity causes the nonuniformity to dissipate.

12. The method of claim 1, wherein the characteristic comprises a thickness of the ribbon.

13. The method of claim 1, wherein the characteristic comprises a temperature of the ribbon.

14. The method of claim 1, wherein the deflected pulsed laser beam impinges on the heating zone at a beam spot that is repeatedly moved within the heating zone along the travel path.

15. The method of claim 1, wherein the deflected pulsed laser beam comprises a plurality of deflected pulsed laser beams impinging on the heating zone at corresponding beam spots arranged as an array of beam spots aligned in the travel direction of the travel path.

16. The method of claim 1, wherein the heating zone comprises an elliptical shape comprising a major axis extending in the travel direction of the travel path.

17. The method of claim 1, wherein the method further comprises controlling a characteristic of the pulsed laser beam to control a heating of the location of the nonuniformity.

18. The method of claim 3, wherein the characteristic comprises a thickness of the ribbon.

19. The method of claim 3, wherein the characteristic comprises a temperature of the ribbon.

20. The method of claim 3, wherein the deflected pulsed laser beam impinges on the heating zone at a beam spot that is repeatedly moved within the heating zone along the travel path.
